(19) United States
(12) Patent Application Publication
(10) Pub. No.: US 2007/0187225 A1
(43) Pub. Date: Aug. 16, 2007

(54) Method for process water treatment in olefin plants

(76) Inventor: Holger Schmigalle, Wolfratshausen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/638,706

(22) Filed: Dec. 14, 2006

(30) Foreign Application Priority Data
Dec. 15, 2005 (DE) 10 2005 060092.1

(51) Int. Cl. C02F 1/04; B01D 3/00

(52) U.S. Cl. 203/10; 203/14; 203/100

(57) ABSTRACT

A method is described for process water treatment in olefin plants having at least one process steam generator (W1) and at least one cracking furnace (O) for steam cracking of hydrocarbons. It is proposed to pass the process water for process water stripping to the process steam generator (W1) and to feed the vaporized process water to the cracking furnace (O). The process steam generator (W1) can be connected downstream of a stripping column (T1), the process water, during cleaning of the stripping column (T1), being fed directly to the process steam generator (W1) for process water stripping, bypassing (B) the stripping column (T1).

The invention relates to a method for process water treatment in olefin plants having at least one process steam generator and at least one cracking furnace for steam cracking of hydrocarbons.

In process water treatment in olefin plants, customarily there is at least one treatment step in the process water stripping stage. Here the problem frequently occurs that the process water system, in particular the stripping column, has a severe fouling behaviour. The fouling is principally caused by polymerization or unsaturated hydrocarbon components. Owing to the severe fouling, frequently desired running times of an olefin plant cannot be met or complex doubling of apparatus is necessary. Also, the amount of wastewater can increase greatly and the wastewater quality can be impaired, so that considerable additional capital expenditure can be required.

The object underlying the present invention is to design a method of the type mentioned at the outset in such a manner that the fouling problem in olefin plants is decreased.

This object is achieved according to the invention by the means that the process water is passed for process water stripping to the process steam generator and the vaporized process water is fed to the cracking furnace.

In an advantageous variant of the invention, the process water, after an upstream stripping in a stripping column, is passed for further process water stripping to the process steam generator. Owing to the additional stripping of the process water in the process steam generator, the wastewater quality, on account of the additional purification effect in the process steam generator, can be significantly improved.

Expediently, the process water, during a cleaning phase in which the upstream stripping column is cleaned, is fed directly to the process steam generator, bypassing the stripping column. In this manner it is ensured that the plant can continue to operate during the cleaning of the stripping column necessary owing to fouling problems. The required process water stripping proceeds in this case in the process steam generator by way of substitution.

According to a preferred embodiment of the invention, the non-vaporized process water is decanted off from a, for example, process water separator constructed as a container. The water excess taken off from this container is finally fed to a wastewater purification plant.

A particularly preferred variant of the invention provides that the stripping column and the process water separator are operated at the same process temperatures and the same process pressures. In another advantageous variant, the stripping column is operated at a lower pressure and a lower temperature than the process water separator. In this case, the process water is heated before delivery to the process steam generator.

Alternatively, the stripping column can be eliminated completely, and the process water can be fed directly to the process steam generator for process water stripping. In this variant, the process steam generator should be designed with a reserve, in order to enable cleaning of the process steam generator in the event of fouling problems without shutting off the plant.

An essential advantage of the invention is that the stripping column can be cleaned without the plant having to be shut down. The desired amounts of wastewater and wastewater specifications can be maintained even during the disconnection of the stripping column. The inventive system can be carried out in connection with a low-pressure stripper (approximately 1.5 bar), a high-pressure stripper (approximately 8 bar) or else completely without stripper. In the latter case, the process water is stripped directly to the cracking furnace. A further advantage results from the fact that owing to the series connection of stripping stages, a higher-grade wastewater specification can be maintained with respect to volatile components. As a result, a wastewater stripper possibly necessary in conventional systems can be omitted.

The invention is to be described in more detail hereinafter on the basis of exemplary embodiments shown diagrammatically in the figures.

In the Drawings

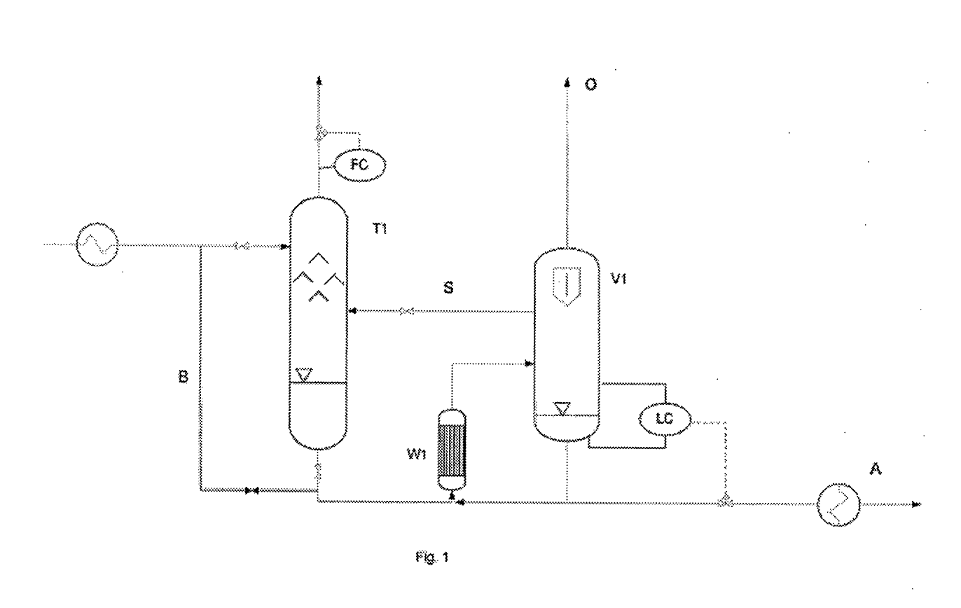

FIG. 1 shows a plant having a high-pressure stripper

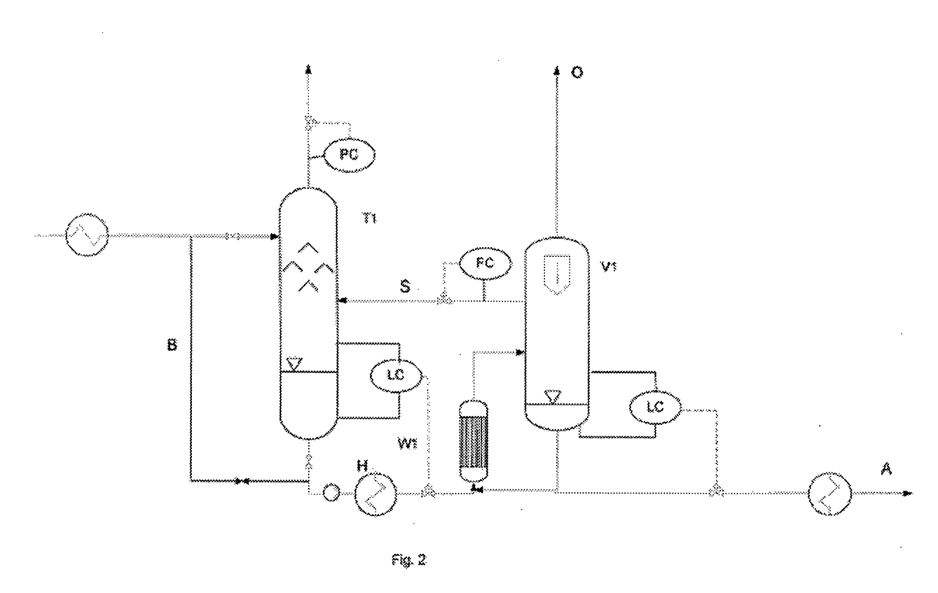

FIG. 2 shows a plant having a low-pressure stripper

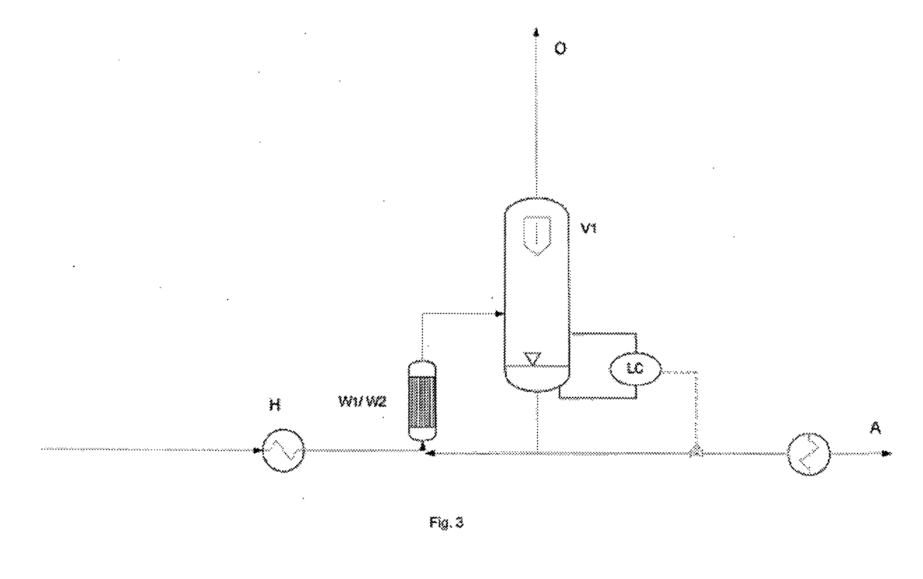

FIG. 3 shows a system without stripping column.

As shown in the variant of FIG. 1, the process water is stripped in a high-pressure stripping column T1. This stripping column T1 is mounted in such a manner that the process water can be transported from the stripping column T1 to the process steam generator W1, which is constructed as a conventional evaporator, and also from the downstream container V1 to the process steam generator W1 without further pumps. In the process steam generator W1, the process water is vaporized and run via the container V1 to the cracking furnaces O. A part of the vapour is recirculated to the stripping column T1 via a line S for stripping. A water excess is decanted off from the container V1 for wastewater treatment. The excess water is passed via line A to a wastewater purification plant which is not shown. In the case of required cleaning of the stripping column T1, via a bypass line B, the process water is passed directly to the process steam generator W1. As a result of the continuing stripping effect in the process steam generator W1, the desired wastewater amount and wastewater quality can continue to be achieved. Outside the cleaning phase, that is when the stripping column T1 and the process steam generator W1 are series-connected, an essential improvement in wastewater quality compared with conventional methods is achieved. In the present embodiment, the process conditions of the stripping column T1 and the container V1 are identical. The temperature is approximately 180 degrees Celsius and the pressure approximately 8 bar.

FIG. 2 shows the flow chart of a process water treatment having a low-pressure stripping column T1 which operates at a lower pressure (1.5 bar) and lower temperature (120 degrees Celsius). The stripped process water is pumped from the stripping column T1 to the process steam generator W1 via an additional heater H, whereas it circulates from the container V1 to the process steam generator W1 without pumps. In the process steam generator W1 the process water is vaporized and run via the container V1 to the furnaces O. A part of the vapour is passed via line S to the stripping column T1 and is used there for stripping. A water excess is decanted off from the container V1 for wastewater treatment. The water excess is fed via line A to a wastewater purification plant which is not shown. In the case of required cleaning of the stripping column T1, the process water is pumped directly to the process steam generator W1 via a bypass line B. In this embodiment, the process conditions of the stripping column T1 and the container V1 are different.

In the variant shown in FIG. 3, the stripping column is omitted completely. The process water is run directly to the process steam generator W1. From the container V1, the process water arrives back at the process steam generator W1 by natural circulation. In the process steam generator W1, the process water is vaporized and passed via the container V1 to the furnaces O. A water excess is decanted off from the container V1 for wastewater treatment and passed via line A to a wastewater purification plant. In this variant, the process steam generator W1 must be designed with a reserve W2, so that cleaning is possible without shutting off the plant.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 102005060092.1, filed Dec. 15, 2005, is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Method for process water treatment in olefin plants having at least one process steam generator (W1) and at least one cracking furnace (O) for steam cracking of hydrocarbons, characterized in that the process water is passed for process water stripping to the process steam generator (W1) and the vaporized process water is fed to the cracking furnace (O).

2. Method according to claim 1, characterized in that the process water, after an upstream stripping in a stripping column (T1), is passed for further process water stripping to the process steam generator (W1).

3. Method according to claim 1, characterized in that the process water, during a cleaning phase in which a stripping column (T1) connected upstream of the process steam generator (W1) is cleaned, is passed directly to the process steam generator, (W1) bypassing the stripping column (T1).

4. Method according to claim 1, characterized in that the vaporized process water is fed to a container (V1) connected upstream of the cracking furnace (O) for decanting off water excess.

5. Method according to claim 4, characterized in that the stripping column (T1) and the container (V1) for decanting off water excess are operated at the same process temperatures and the same process pressures.

6. Method according to claim 4, characterized in that the stripping column (T1) is operated at a lower pressure and lower temperature than the container (V1) for decanting off the water excess and the process water is heated before delivery to the process steam generator (W1).

7. Method according to claim 1, characterized in that the process water is fed, without upstream connection of a stripping column (T1), directly to the process stream generator (W1) for process water stripping.
